(19) United States
(12) Patent Application Publication
(10) Pub. No.: US 2025/0283842 A1
(43) Pub. Date: Sep. 11, 2025

(54) SYSTEMS AND METHODS FOR X-RAY FLUORESCENCE SPECTROMETRY OPTICS ALIGNMENT

(71) Applicant: IXRF, Inc., Austin, TX (US)

(72) Inventors: Robert Clayton Tisdale, Austin, TX (US); Andrew Ma, Austin, TX (US)

(73) Assignee: IXRF, Inc., Austin, TX (US)

(21) Appl. No.: 19/068,196

(22) Filed: Mar. 3, 2025

Related U.S. Application Data
(60) Provisional application No. 63/561,419, filed on Mar. 5, 2024.

(51) Int. Cl. G01N 23/223; G01N 23/2209

(52) U.S. Cl. CPC G01N 23/223; G01N 23/2209; G01N 2223/303; G01N 2223/32

(57) ABSTRACT

In some embodiments, an alignment apparatus for an X-ray source may include an X-ray tube configured to emit X-rays. The alignment apparatus for an X-ray source may include an optical alignment assembly situated between the X-ray tube and sample. The optical alignment assembly may include a flight tube and at least one adjustment mechanism. The optical alignment assembly may be adjustable to ensure the emitted X-rays produce an illumination on the sample with maximized X-ray intensity and desired spot shape. In some embodiments, a method may include emitting X-rays from an X-ray tube along a central axis. The method may include adjusting an optical alignment assembly in a first linear direction perpendicular to the central axis and a first rotational direction around the central axis to align the optical alignment assembly with the X-ray tube. The method may include illuminating a sample with maximized X-ray intensity and desired spot shape.

### CROSS-REFERENCE TO RELATED APPLICATIONS

This application claims the benefit of priority under 35 U.S.C. § 119(e) to prior U.S. Provisional Patent Application No. 63/561,419 filed on Mar. 5, 2024, the disclosure of which is incorporated by reference herein in its entirety.

### FIELD OF DISCLOSURE

The disclosed systems and methods relate to the field of elemental analysis. More particularly, the disclosed systems and methods are directed to X-ray fluorescence (XRF) spectrometry optics alignment.

### BACKGROUND

XRF measurement is used in materials analysis. XRF is a technique for determining the elemental composition and other properties, such as thickness, of a sample. XRF analyzers include an X-ray source, which irradiates the sample with sufficient energy to excite X-ray fluorescence from the elements of interest within the sample. XRF spectrometers also include an X-ray detector for detecting the X-ray fluorescence emitted by the sample in response to the irradiation. Each element in the sample emits X-ray fluorescence at discrete energies that are characteristic of the element. The detected X-ray fluorescence is analyzed to find the energies or the wavelengths of the detected photons, and the number of emitted photons (i.e., intensity) as a function of energy or wavelength. The detected X-ray fluorescence can also determine the qualitative composition, quantitative composition, thickness, and other properties of the sample.

For homogenous samples, the sample area measured is often not critical. However, some samples, such as powder mixtures and structured materials, can be inhomogeneous. As such, XRF measurements may be carried out to measure the inhomogeneity across a sample. In such cases, there is a need to measure X-ray emissions from a small sample spot generated by some optical system. Conventional systems require manual alignment of the XRF optics or use of XY translation of the optics in a plane perpendicular to the bream produced by the X-ray tube anode exiting through the beryllium (Be) X-ray tube exit window. If the optical system is not precisely coaxial with the X-ray tube emission spot on the X-ray tube anode, the result will be a misshapen focal spot on the sample, typically a crescent shape of diminished X-ray intensity per area (fluence).

### SUMMARY

In some embodiments, an alignment apparatus for an X-ray source may include an X-ray tube configured to emit X-rays. The alignment apparatus for an X-ray source may include an optical alignment assembly situated between the X-ray tube and a sample. The optical alignment assembly may include a flight tube and at least one adjustment mechanism. The optical alignment assembly may be adjustable to ensure the emitted X-rays produce an illumination on the sample with maximized X-ray intensity and desired spot shape.

In some embodiments, a method may include emitting X-rays from an X-ray tube along a central axis. The method may include adjusting an optical alignment assembly in a first linear direction perpendicular to the central axis and a first rotational direction around the central axis to align the optical alignment assembly with the X-ray tube. The method may include illuminating a sample with maximized X-ray intensity and desired spot shape.

In some embodiments, a method may include providing a reference device for analysis. The method may include adjusting a radial distance of an optical train. The method may include energizing an X-ray tube to a predetermined voltage and emission current. The method may include recording an X-ray count. The method may include moving an optical alignment assembly to a first radius value perpendicular to a central axis. The method may include adjusting an angle (Θ) of the optical alignment assembly through a full 360-degree rotation while the X-ray count rate is monitored to identify the angle at which the X-ray count rate is maximized. The method may include recalibrating the optical train based on the previously observed maximum flux.

### BRIEF DESCRIPTION OF THE DRAWINGS

The features and advantages of the present disclosure will be more fully disclosed in, or rendered obvious by, the following detailed descriptions of example embodiments. The detailed descriptions of the example embodiments are to be considered together with the accompanying drawings wherein like numbers refer to like parts and further wherein:

FIG. 1 illustrates aspects of an exemplary XRF system in accordance with some embodiments;

FIG. 2 illustrates a side view of one example of an optical alignment assembly for an XRF system in accordance with some embodiments;

FIG. 3 illustrates a front view of one example of an optical alignment assembly of an XRF system in accordance with some embodiments;

FIG. 4 illustrates an exemplary diagram of an X-ray beam emitted through pinhole apertures in accordance with some embodiments;

FIG. 5 illustrates a block diagram of one example of an exemplary computing device of an XRF system in accordance with some embodiments;

FIG. 6 illustrates a flow diagram of one example of a method of alignment of an optical train of an XRF system in accordance with some embodiments; and

FIG. 7 illustrates another example of a flow diagram of a method of aligning an optical train of an XRF system in accordance with some embodiments.

While the present disclosure is susceptible to various modifications and alternative forms, specific embodiments have been shown by way of example in the drawings and will be described in detail herein. It should be understood, however, that the present disclosure is not intended to be limited to the particular forms disclosed. Rather, the present disclosure is to cover all modifications, equivalents, and alternatives falling within the spirit and scope of the disclosure as defined by the appended claims.

### DETAILED DESCRIPTION

This description of the exemplary embodiments is intended to be read in connection with the accompanying drawings, which are to be considered part of the entire written description. It should be understood, however, that the present disclosure is not intended to be limited to the particular forms disclosed and that the drawings are not necessarily shown to scale. Rather, the present disclosure covers all modifications, equivalents, and alternatives that fall within the spirit and scope of these exemplary embodiments. In the description, relative terms such as “lower,” “upper,” “horizontal,” “vertical,” “above,” “below,” “up,” “down,” “top,” and “bottom” as well as derivatives thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected” refer to a relationship wherein structures are secured or attached to one another either directly or indirectly through intervening structures, as well as both movable or rigid attachments or relationships, unless expressly described otherwise. The terms “couple,” “coupled,” “operatively coupled,” “operatively connected,” and the like should be broadly understood to refer to connecting devices or components together either mechanically, or otherwise, such that the connection allows the pertinent devices or components to operate with each other as intended by virtue of that relationship.

The present disclosure relates to X-ray fluorescence (XRF) elemental analysis along with imaging and mapping spectrometric measurements of a broad range of sample types and sizes. More particularly, the disclosure is concerned with small-spot XRF (e.g., approximately 1-25 mm), mesoXRF (e.g., approximately from 1 mm), and microXRF (e.g., approximately down to a few microns), which are sub-types of X-ray fluorescence elemental analysis imaging and mapping spectrometric measurements of surfaces of micro- to meso- and macro-scale objects. However, one of ordinary skill in the art will understand that the disclosure may be extended to other types of XRF. The disclosure includes an apparatus for X-ray fluorescence spectrometric analysis that involves excitation of samples with a micro- or meso-scale X-ray beam, detection of characteristic X-rays, analysis of such X-rays, and movement along multiple axes to perform point measurement and/or map the X-ray intensities emanating and/or reflected from the surface of the object, using both calibrated intensities from known reference materials as well as standardless mathematical treatments based on fundamental parameters of the atomic elements.

Small-spot, meso-spot, or micro-spot mapping XRF may be coupled with Cartesian geometry motorized high-precision stages (XY or XYZ, where Z is the distance from the sample to the X-ray source) that move a sample from point-to-point or in some scanning pattern proximate to a stationary spectrometer. Alternatively, the spectrometer may be moved point-to-point and/or scanned across a plurality of stationary samples. By stepping or slewing in a controlled way, multiple XRF spectra may be accumulated where each spectrum is assigned to a specific pixel so as to form a two-dimensional (2D) map or image of a measured area. Stepping from point-to-point, followed by measurement, yields a two dimensional dataset with known measurement coordinates. In this way, a data cube of locations and their associated spectra are collected. Multiple map images of a sample, or portion of a sample, may be displayed on an element-by-element basis with different faux coloration per element. For example, colors may be assigned such that brighter color is indicative of higher concentration of any given element or vice versa.

In order to focus the X-ray beam for a small or point spot size on a sample, a collimation (e.g., pinhole collimator) or a capillary lens (e.g., mono- or poly-capillary) system (hereinafter “optical train”) may be used. In order to align the optical train with the X-ray tube, a movement mechanism may be used to rotate and/or translate the optics systems for a desired spot size and shape for the X-ray source assembly, while maximizing the X-ray intensity. For example, the rotation mechanism may include a stage to allow the optics to rotate around some radius (r) to any angle (Θ) needed to achieve the desired spot size or shape. Utilizing translational and/or rotational movements in conjunction with the collimator's aperture design ensures precision in focusing, or constricting, the X-ray beam to a specific size, which is useful for applications requiring detailed X-ray analysis. Other methods and apparatuses for a collimator may be found in Japanese Patent No. JP 3635606, United Kingdom Patent No. GB 2,359,717, European Patent No. 3,330,701, and U.S. Pat. Nos. 6,483,894, 10,281,414, and 10,598,615, the entireties of which are incorporated herein by reference.

As an example, the collimated or focused, and optionally filtered, primary radiation may pass through some path and interact with a sample before the resulting characteristic X-rays from the sample, along with scatter and other spectral artifacts, are recorded by the X-ray detector after passing through the path again. The path may be air, some gas (typically nitrogen or helium) or a partial vacuum. In an embodiment, the sample may rest on a mechanized XYZ-stage to move the sample under the spectrometer so that multiple spots may be analyzed automatically. The stage may also be used to map an elemental image of a sample according to some embodiments.

Other XRF collimation techniques may be found in: (1) Polycapillary conic collimator for micro-XRF, Bzhaumikhov, A. A., Langhoff, N., Schmalz, J., Wedell, R., Beloglazov, V. I., & Lebedev, N. F, X-Ray Optics, Instruments, and Missions (Vol. 3444, pp. 430-435), 19 Nov. 1998; (2) Handheld Macro-XRF Scanning: Development of Collimators for Sub-mm Resolution, Shugar, A. N., Proceedings of the Fourth International Symposium on Analytical Methods In Philately (pp. 13-20), 13-14 Nov. 2020; (3) A portable micro-X-ray fluorescence spectrometer with polycapillary optics and vacuum chamber for archaeometric and other applications, Buzanich, G., Wobrauschek, P., Streli, C., Markowicz, A., Wegrzynek, D., Chinea-Cano, E., & Bamford, S., Spectrochimica Acta Part B: Atomic Spectroscopy, Vol. 62, Issue 11, pp. 1252-1256 November 2007; (4) Component selection for a compact micro-XRF spectrometer, Bichlmeier, S., Janssens, K., Heckel, J., Gibson, D., Hoffmann, P., & Ortner, H. M., X-Ray Spectrometry: An International Journal, Vol. 30, Issue 1, pp. 8-14, 14 Mar. 2001; (5) Energy-dispersive X-ray fluorescence spectrometer for analysis of conventional and micro-samples: Preliminary assessment, Sitko, R., Zawisza, B., & Malicka, E., Spectrochimica Acta Part B: Atomic Spectroscopy, Vol. 64, Issue 5, pp. 436-441, May 2009; and (6) X-ray Spectrometry: Recent Technological Advances, Tsuji, K., Injuk, J., & Van Grieken, R. (Eds.), John Wiley & Sons, pp. 63-131, 15 Mar. 2004, the entireties of which are incorporated herein by reference.

Disclosed herein are X-ray fluorescence analysis apparatuses that may include: (1) an X-ray source for excitation of a sample; (2) a collimation or lens optical system to project or focus the X-ray radiation beam to a controlled spot size on a sample; (3) an X-ray detector for detecting characteristic X-rays and scattered X-rays and outputting a signal containing energy and intensity information on the characteristic X-rays and the scattered X-rays; (4) an analyzer for analyzing the signal; and (5) a spectrometer stage assembly capable of moving an irradiation point (e.g., X-, Y- and Z-axes or in a polar coordinate system) with respect to the surface of a measured object.

The optical alignment assemblies disclosed herein may be situated between the X-ray source and the sample object. The optical alignment assemblies may include either a pinhole collimator optic to project a meso-scale X-ray spot, or a mono- or poly-capillary lens or reflection optic sub-assembly to focus a micro-scale X-ray spot onto the sample. The optical alignment assemblies may include a rotation and translation mechanism for rapid optimization of the projection of the X-ray source through the collimation or lens subassembly. The disclosed optical alignment assemblies are an improvement over prior art apparatuses by maximizing X-ray intensity while ensuring proper spot size and shape. Methods of operation also are disclosed.

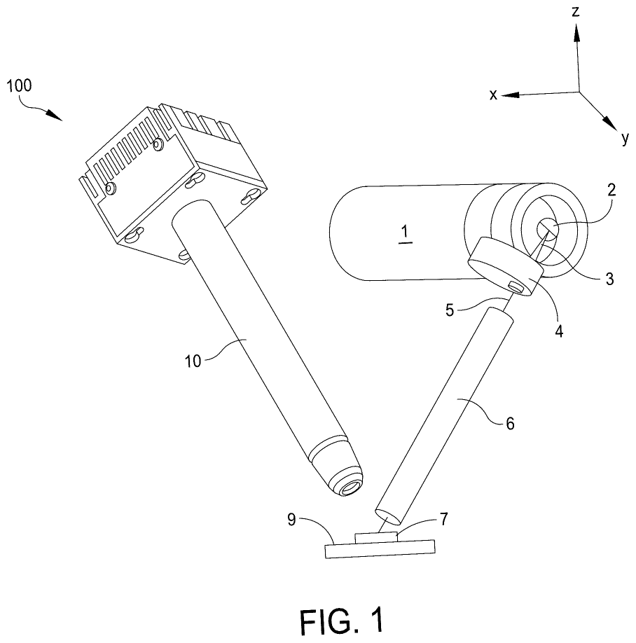

Referring now to the figures, FIG. 1 illustrates aspects of an exemplary XRF system 100 in accordance with some embodiments. The XRF system 100 may be configured for meso- or micro-scale XRF analysis. XRF of other scales may also be used. The XRF system 100 may include an X-ray tube 1 having an anode 2 designed to emit a divergent primary X-ray beam 3. The XRF system 100 may include a filtering foil system 4 operatively coupled to the X-ray tube 1. In some embodiments, the filtering foil system 4 may be configured as a motorized revolving wheel, as illustrated in FIG. 1, having multiple filtering materials selected from metal, plastic, doped plastic coupons, or stacked foils of varying thicknesses. In other embodiments, the filtering foil system 4 may be configured as a linear translation device including a plurality of filtering materials. In either case, the filtering foil system 4 may be configured to modify the primary X-ray beam 3 to produce a divergent X-ray beam 5 with a modified continuum.

The XRF system 100 may also include an r-theta optical alignment assembly 6. The optical alignment assembly 6 may include cither a capillary (mono- or poly-capillary) lens optic, a multi-pinhole optical train, or a reflection optical assembly. For example, the reflection optical assembly may be a Göbel mirror or Montel optic. The optical alignment assembly 6 may be configured to receive the modified X-ray beam 5 and project a micro- or meso-scale beam onto the surface of a sample 7.

The XRF system 100 may also include a movable sample stage 9, capable of positioning the sample 7 in X-, Y-, and Z-directions. The sample stage 9 may operate in the plane of the sample 7 and may facilitate movement of the sample 7 using some scanning or stepping modality. For example, the sample stage 9 may employ linear motor actuators, an r-Θ mechanism for rotation of the sample 7 to some angle (Θ) around a radius (r), or may use a multi-axis robotic system. For enhanced mapping capability, the sample stage 9 may allow for movement in the Z-direction to adjust the sample 7 to XRF system 100 distance, ensuring consistent distance maintenance from the surface of an irregular sample. Although the sample stage 9 has been discussed as movement of the sample 7 with a fixed spectrometer system, it will be appreciated that one or more components of the XRF system 100 may be on a stage similar to sample stage 9 with the sample 7 being stationary. For example, the X-ray tube 1 and/or the optical alignment assembly 6 may be on a stage that is configured to move relative to the sample 7.

The XRF system 100 may also include one or more X-ray detectors 10 situated to measure characteristic X-ray fluorescence radiation emitted from the sample 7 in response to the incident X-rays and portions of the reduced cross-section incident X-ray beam scattered or diffracted by the sample 7. The X-ray detector 10 may be configured to relay the associated detector signals to an electronic evaluation unit for analysis, which may be part of XRF system 100 or may be remote from XRF system 100.

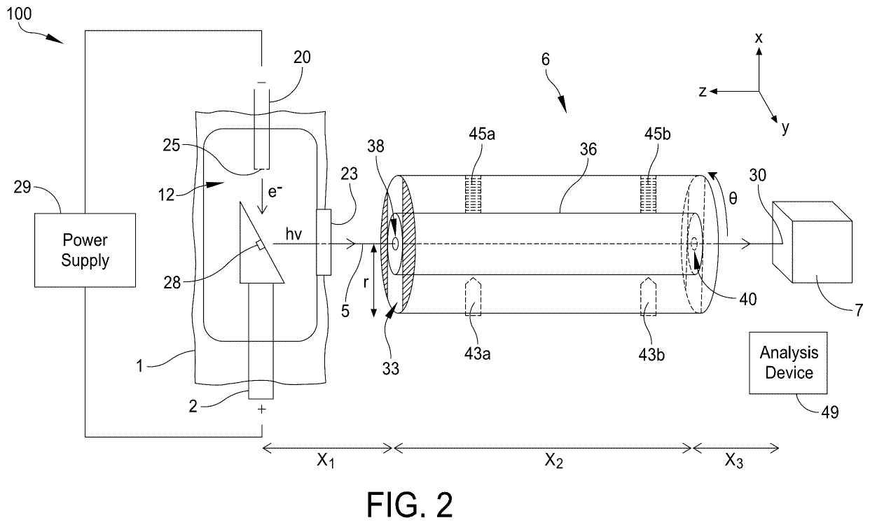

FIG. 2 illustrates a side view one example of an optical alignment assembly 6 for an XRF system 100 in accordance with some embodiments. The optical alignment assembly 6 in FIG. 2 is used for aligning an X-ray beam 5 in an X-ray tube 1 to achieve precise focal spot characteristics on a sample 7. In some embodiments, the XRF system 100 may include an X-ray tube 1 that includes an envelope 12 disposed within the X-ray tube 1. In some embodiments, the envelope 12 may be at a sub-atmospheric pressure. For example, the pressure may be a high vacuum environment to facilitate an electron flow under high potential. The envelope 12 may be configured to enclose the anode 2 and a cathode 20, ensuring their operation within the sub-atmospheric pressure of the envelope 12. The anode 2 may be positioned within the envelope 12 to collect electrons (e⁻) emitted from the cathode 20 under the influence of an electric field between the anode 2 and cathode 20. In some embodiments, the X-ray emission may resemble a point source. In some embodiments, the envelope 12 may be an electrically insulating glass or ceramic vessel conducive for maintaining the sub-atmospheric pressure within the X-ray tube 1.

The XRF system 100 may further include an exit window 23 for the transmission of X-rays. The exit window 23 may allow the generated X-rays (illustrated as photons (hv)) to exit the tube while maintaining a sub-atmospheric environment within the envelope 12. In some embodiments, the exit window 23 may be a material including beryllium (Be). The anode 2 may be used to collect electrons (e⁻) and the cathode 20 may include a filament 25, or field emitter, for electron emission. For example, the filament 25 may be a resistively heated wire structure within the cathode 20 that is the source of the electrons emitted into the sub-atmospheric environment. In some embodiments, the filament 25 may be a material including tungsten. The electrons may impact the anode 2 at an emission spot 28. The emission spot 28 may be a small area on the anode 2 where accelerated electrons from the filament 25 impact and decelerate, resulting in the emission of both characteristic X-rays and Bremßtrahlung radiation. The XRF system 100 may operate under a voltage provided by an external voltage power supply 29 to accelerate electrons from the cathode 20 to the anode 2. In some embodiments, a micro-focus transmission target end-window X-ray tube may be employed.

The optical alignment assembly 6 may be adjustable around a Z-axis by an angle theta (Θ) for optimal collimation and focusing of X-rays from the emission spot 28 onto a focal spot 30 on a sample 7. The optical alignment assembly 6 may define a slotted hole 33 that allows movement (e.g., rotational, translational, etc.) of a flight tube 36. For example, the slotted hole 33 may run the length of the optical alignment assembly 6 and allow for translation of the flight tube 36 by some distance (r). The flight tube 36 may include one or more entry pinhole apertures 38 and one or more exit pinhole apertures 40. The entry pinhole aperture 38 and the exit pinhole aperture 40 may be used for collimation of the X-ray beam 5. In some embodiments, the flight tube 36 may incorporate additional pinholes (e.g., entry pinhole aperture 38, exit pinhole aperture 40, or additional apertures between the entry and exit) for further beam shaping, such as change in size, shape, and fluence. In some embodiments, the flight tube 36 may be a straight high-strength alloy tube, typically internally sleeved with a substantially pure aluminum (Al) tube to suppress parasitic X-ray fluorescence.

The optical alignment assembly 6 may include one or more adjustment screws 43a-b, or micrometer mechanisms, to facilitate the movement (e.g., rotation, translation, etc.) of the flight tube 36. The optical alignment assembly 6 may also include one or more retainer devices 45a-b configured to ensure the correct tension on the flight tube 36. The retainer devices 45a-b may be springs under compression. However, the retainer devices 45a-b could also comprise a plurality of counter adjustment screws. In some embodiments, the adjustment screws 43a-b may be used to translate the flight tube 36 by some distance (r) in tension against a retainer devices 45a-b. In some embodiments, a plurality of adjustment screws 43a-b and retainer devices 45a-b are employed to allow for off-axis correction of the flight tube 36 to compensate for dimensional errors associated with a fixturing assembly connecting the X-ray tube 1 with the optical alignment assembly 6.

Translation of the flight tube 36 by some distance (r) using the adjustment screws 43a-b coupled with rotation of the optical alignment assembly 6 by some angle (Θ) allows coaxial alignment of the flight tube 36 to the optical train of the XRF system 100. The optical alignment assembly 6 may also allow for correction of off-axis errors through the rotation of the optical alignment assembly 6 to some angle theta (Θ) and/or the translation of the flight tube 36 by some distance (r). In some embodiments, the optical alignment assembly 6 may include a capillary X-ray lens within an alloy flight tube 36 instead a flight tube 36 and pinhole configuration (e.g., entry pinhole aperture 38 and exit pinhole aperture 40) as discussed above.

The focal spot 30 may be projected onto a sample 7 with a defined size and shape. The size and shape of the focal spot 30 may be determined by: (1) the positioning of the flight tube 36, (2) distance (x₁) of the optical alignment assembly 6 from the emission spot 28, (3) length (x₂) of the optical alignment assembly 6, (4) distance (x₃) of the optical alignment assembly 6 from the sample 7, (5) the diameters of the pinhole apertures (e.g., entry pinhole aperture 38 and/or exit pinhole aperture 40) of the flight tube 36, and/or (6) the number of pinhole apertures (e.g., entry pinhole aperture 38, exit pinhole aperture 40, and/or additional apertures between the entry and exit) of the flight tube 36. In some embodiments, the distance (x₁) between the emission spot 28 and the entry pinhole aperture 38, the length (x₂) of the optical alignment assembly 6 and flight tube 36, and the distance (x₃) between the exit pinhole aperture 40 and the sample 7 may be selected along with the pinhole (e.g., entry pinhole aperture 38 and exit pinhole aperture 40) internal diameters based on calculations and/or empirical experimentation to achieve the desired focal spot 30 size and shape.

In some embodiments, the distances x₁, x₂, and x₃ may also determine an optical focal spot 30 for a capillary embodiment of the optical alignment assembly 6. The sample 7 may be analyzed via an analysis device 49, such as by X-ray fluorescence spectroscopy or by imaging sensors for direct observation of the focal spot 30 size and shape, or by an X-ray count rate sensor to maximize flux or fluence. The imaging sensors may include complementary metal oxide semiconductor (CMOS), hybrid pixel array detectors (HPAD), or charge couple device (CCD) just to give a few possible examples. In some embodiments, the sample 7 may be an X-ray count rate sensor with associated electronics used for the purpose of r-theta (r-Θ) alignment of the optical alignment assembly 6 to achieve maximum flux (photons/s) or fluence (photons/s/area). In some embodiments, imaging or count rate sensor data may be used by a computing device to control motorized and/or automated alignment of the optical alignment assembly 6. For example, all rotations and translations described herein may be motorized and/or automated, facilitated by a computing device, such as computer device 200 described in more detail below, that may be considered part of analysis device 49.

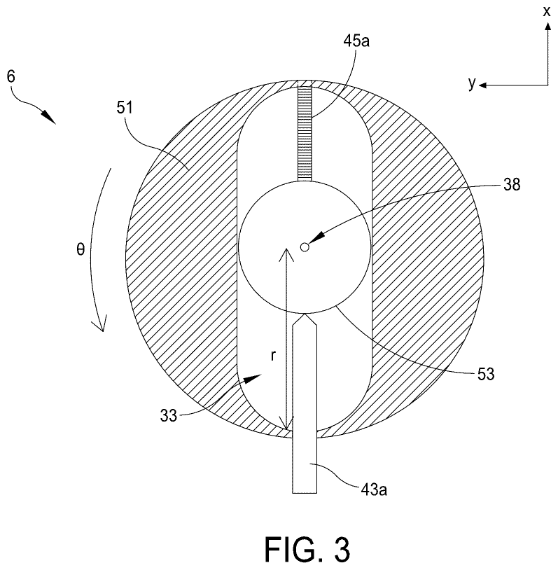

FIG. 3 illustrates a front view of one example of an optical alignment assembly 6 for the optics of an XRF system 100 in accordance with some embodiments. The optical alignment assembly 6 may be suited for either a capillary lens or pinhole collimator. The optical alignment assembly 6 may be configured to rotate about the long Z-axis by an angle (Θ) to optimally collimate or focus X-rays (e.g., X-ray beam 5) as discussed above, where the Z-axis is orthogonal to the page of FIG. 3. The optical alignment assembly 6 may include solid alloy cylinder 51 with a longitudinally machined slotted hole 33, enabling maximal movement of an optical train 53. In some embodiments, the optical train 53 may be a collimator train or capillary lens assembly.

The rotation and/or translation capabilities of the optical alignment assembly 6 may allow for precise polar coordinate alignment. The optical train 53 may include a high-strength alloy flight tube 36 designed to house and centralize pinhole apertures or a capillary lens. This flight tube 36 may have an internal sleeve made of pure or substantially pure aluminum to curb parasitic X-ray fluorescence. The optical train 53 may use one or more pinhole collimator apertures (e.g., entry pinhole aperture 38 and exit pinhole aperture 40) or utilize a capillary lens in place of the pinholes. The translational movement of the optical train 53 may employ one or more adjustment screws 43a (or micrometers) to modify its distance (r) from the center line, with tension maintained by one or more retainer device 45a, allowing for off-axis error correction if required. The combined translational and rotational adjustments permit the alignment of the optical train 53 with the anode 2 emission spot 28, thereby ensuring the desired projection of the focal spot 30 on the sample 7.

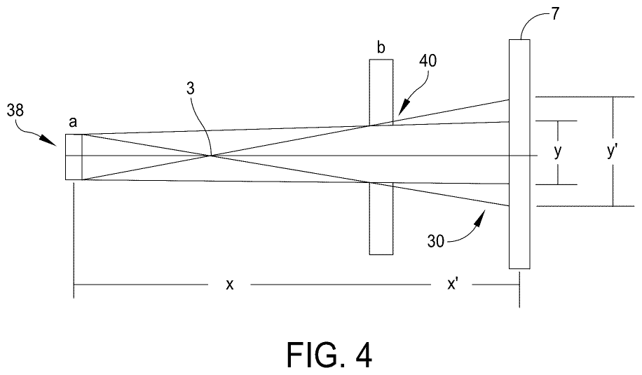

FIG. 4 illustrates an exemplary diagram of an X-ray beam 3 emitted through pinhole apertures (e.g., entry pinhole aperture 38 and exit pinhole aperture 40) in accordance with some embodiments. As an example, a double pinhole system with round apertures (e.g., entry pinhole aperture 38 and exit pinhole aperture 40) adjacent to a micro-focus side window X-ray tube 1 as shown in FIG. 2, the following equations may approximate optical performance where the entry pinhole aperture 38 is very close to the exit window 23:

$$y = b [ ( x / ( b / a - 1 ) + x + {x}^{′} ) / ( x / ( b / a - 1 ) + x ) ] \qquad ( Equation 1 )$$

$${y}^{′} = b [ 1 + {x}^{′} / x ( 1 + a / b ) ] \qquad ( Equation 2 )$$

where,
a is the diameter of the entry pinhole aperture 38;
b is the diameter of the exit pinhole aperture 40;
x is the distance between the entry pinhole aperture 38 and exit pinhole aperture 40;
x′ is the distance between the exit pinhole aperture 40 and the sample 7;
y is the diameter of the focal spot 30 on the sample 7, the part of the beam with the full intensity;
y′ is the diameter of the overall beam on the sample 7, including the penumbra (halo).

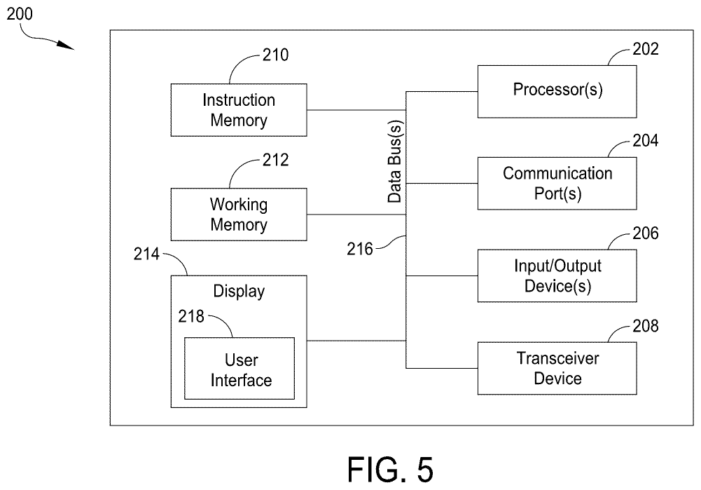

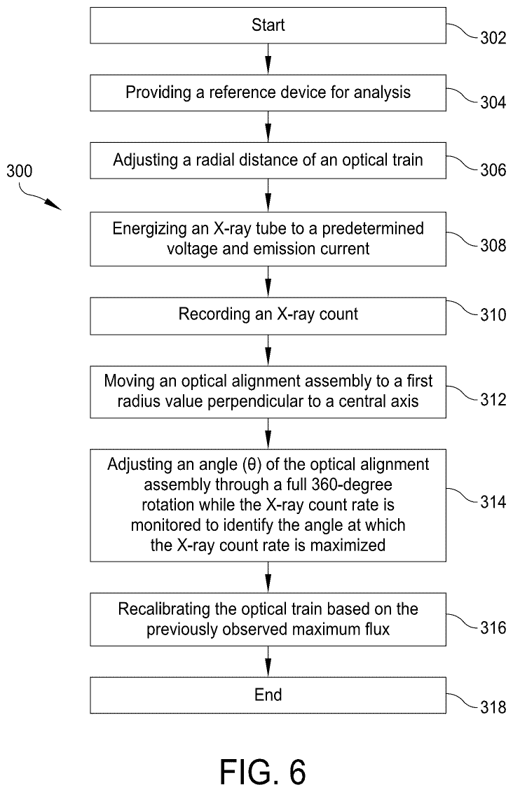

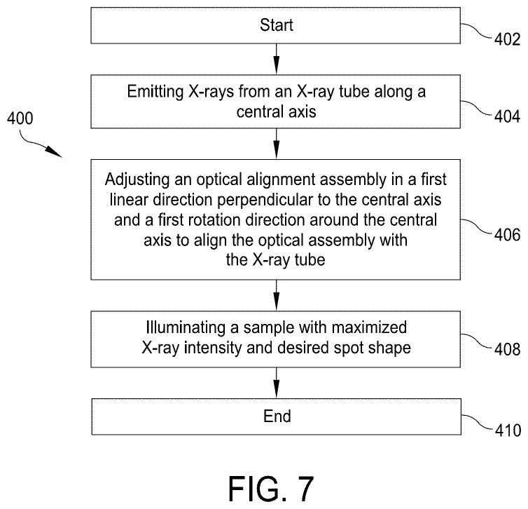

FIG. 5 illustrates a block diagram of one example of an exemplary computing device 200 of an XRF system 100 in accordance with some embodiments. The computing device 200 can be employed by a disclosed system or used to execute a disclosed method of the present disclosure. Computing device 200 may be configured to operate the XRF system 100 and/or to perform the methods illustrated in FIGS. 6-7, as discussed in more detail below. It should be understood, however, that other computing device configurations, including distributed and/or cloud-based systems, are possible.

Computing device 200 can include one or more processors 202, one or more communication port(s) 204, one or more input/output devices 206, a transceiver device 208, instruction memory 210, working memory 212, and optionally a display 214, all operatively coupled to one or more data buses 216. Data buses 216 allow for communication among the various devices, processor(s) 202, instruction memory 210, working memory 212, communication port(s) 204, and/or display 214. Data buses 216 can include wired, or wireless, communication channels. Data buses 216 are connected to one or more devices.

Processor(s) 202 can include one or more distinct processors, each having one or more cores. Each of the distinct processors 202 can have the same or different structures. Processor(s) 202 can include one or more central processing units (CPUs), one or more graphics processing units (GPUs), application specific integrated circuits (ASICs), digital signal processors (DSPs), and the like.

Processor(s) 202 can be configured to perform a certain function or operation by executing code, stored on instruction memory 210. For example, processor(s) 202 can be configured to perform one or more of any function, method, or operation disclosed herein.

Communication port(s) 204 can include, for example, a serial port such as a universal asynchronous receiver/transmitter (UART) connection, a Universal Serial Bus (USB) connection, or any other suitable communication port or connection. In some examples, communication port(s) 204 allows for the programming of executable instructions in instruction memory 210. In some examples, communication port(s) 204 allow for the transfer, such as uploading or downloading, of data. In some embodiments, a wired or wireless fieldbus or Modbus protocol may be used.

Input/output devices 206 can include any suitable device that allows for data input or output. For example, input/output devices 206 can include one or more of a keyboard, a touchpad, a mouse, a stylus, a touchscreen, a physical button, a speaker, a microphone, or any other suitable input or output device.

Transceiver device 208 can allow for communication with a network, such as a Wi-Fi network, an Ethernet network, a cellular network, radio signals, Bluetooth, or any other suitable communication network. For example, if operating in a cellular network, transceiver device 208 is configured to allow communications with the cellular network. Processor(s) 202 is operable to receive data from, or send data to, a network via transceiver device 208.

Instruction memory 210 can include an instruction memory 210 that can store instructions that can be accessed (e.g., read) and executed by processor(s) 202. For example, the instruction memory 210 can be a non-transitory, computer-readable storage medium such as a read-only memory (ROM), an electrically erasable programmable read-only memory (EEPROM), flash memory, a removable disk, CD-ROM, any non-volatile memory, or any other suitable memory with instructions stored thereon. For example, the instruction memory 210 can store instructions that, when executed by one or more processors 202, cause one or more processors 202 to perform one or more of the operations of the XRF system 100.

In addition to instruction memory 210, the computing device 200 can also include a working memory 212. Processor(s) 202 can store data to, and read data from, the working memory 212. For example, processor(s) 202 can store a working set of instructions to the working memory 212, such as instructions loaded from the instruction memory 210. Processor(s) 202 can also use the working memory 212 to store dynamic data created during the operation of computing device 200. The working memory 212 can be a random access memory (RAM) such as a static random access memory (SRAM) or dynamic random access memory (DRAM), or any other suitable memory.

Display 214 can be configured to display user interface 218. User interface 218 can enable user interaction with computing device 200. In some examples, a user can interact with user interface 218 by engaging input/output devices 206. In some examples, display 214 can be a touchscreen, where user interface 218 is displayed on the touchscreen.

FIG. 6 is a flow diagram of one example of a method 300 of alignment of an optical train 53 of an XRF system 100 in accordance with some embodiments. The alignment method 300 may start at block 302. At block 304, a reference device may be provided for analysis. For example, the XRF system 100 may be aligned initially by utilizing an X-ray detection device in the place of the sample 7, for example, a Geiger counter with an appropriate filter, to maximize the passage of X-ray flux through the optical train 53. Alternately, an XRF detector 10, such as a silicon lithium (Si(Li)) detector, cadmium telluride (CdTe) detector, or silicon drift detector (SDD), may be employed to look at some reference sample (i.e., in the place of the sample 7) or carbon stub X-ray reflector, for the maximum flux alignment procedure. The method 300 may include the process(es) performed at block 306, which may comprise adjusting a radial distance (r) of an optical train 53. The adjustment may be through increments of at least one micrometer, or multiple thereof, which may allow for the easy recalibration to an optimal ‘r’ value following an overshoot of the value during the iterative alignment process.

The method 300 may include the process(es) performed at block 308, which may comprise energizing an X-ray tube 1 to a predetermined voltage and emission current. In some embodiments, the optical alignment assembly 6 may be initially positioned at an angle (Θ) of zero degrees and the ‘r’ value set to zero, corresponding to the center of radial travel. The method 300 may include the process(es) performed at block 310, which may comprise recording the X-ray count. The method 300 may include the process(es) performed at block 312, which may comprise moving an optical alignment assembly 6 to a first radius value perpendicular to a central axis, such as axis Z. The method 300 may include the process(es) performed at block 314, which may comprise adjusting the angle (Θ) of the optical alignment assembly 6 through a full 360-degree rotation while the X-ray count rate is monitored to identify the angle at which the X-ray count rate is maximized. In some embodiments, the adjustment of the angle (Θ) is performed incrementally or continuously. Should this count rate exceed that of the initial rate observed at the angle equal to zero degrees and ‘r’ equal to zero, the process is reiterated. This involves incrementing the ‘r’ value by an additional minimal positive amount and again rotating through an angle (Θ) to discern the peak counting rate position. This sequence is continued until a decline in X-ray flux is detected.

The method 300 may include the process(es) performed at block 316, which may comprise recalibrating the optical train 53 based on the previously observed maximum flux. For example, the radial distance and theta coordinates (r-Θ) corresponding to the previously observed maximum flux represents the optimal alignment configuration. The method 300 may end at block 318. In some embodiments, the method 300 may include moving the optical alignment assembly 6 to at least a second radius value. In some embodiments, the method 300 may also include observing the reference device during the angle adjustment and movement to at least one of the radius values to ensure a desired spot size, spot shape, and maximum X-ray flux or fluence is achieved. In some embodiments, all rotations and translations described herein may be motorized and/or automated, facilitated by a computing device 200. For example, the angle adjustment and the movement of the optical alignment assembly 6 to the first radius value may be motorized or automated.

In a subsequent stage of alignment for an XRF system 100, the objective may be to refine the focal spot 30 size and profile at a specified working distance downstream from the terminal pinhole of a collimator sequence or the distal tip of a capillary lens (e.g., distance x₃). The scanning of an edge of a pure element foil or a slender wire across the X-ray beam 5 in orthogonal X and Y axes may be used to ascertain the beam width from the full width at half maximum (FWHM) value derived from a derivative of the gradient of the intensity-versus-distance plot. In some embodiments, focal spot 30 size may be determined by the utilization of a direct-reading radiographic imaging detector.

Specialized X-ray beam imaging apparatuses, such as those in the Rigaku® XSight™ series may be used. In some embodiments, a more economical alternative may employ intra-oral dental X-radiographic sensors, which offer the convenience of a single USB connection to a computing device, such as computing device 200 discussed above. This sensor may be positioned at the locus where the sample 7 would typically reside, permitting the X-ray beam 5 to be directly captured at a desired voltage and emission current, and subsequently displayed on the computer monitor (e.g., display 214) as a scaled image.

Particularly in instances involving dual pinhole collimators, any deviation from precise coaxial alignment may be revealed on the imaging sensor as either elliptical or crescent-shaped foci. Given that the preceding alignment phase has established peak flux, minor differential modifications to the radial distance (r) pertaining to the entry pinhole aperture 38 and exit pinhole aperture 40 may be used to rectify distortions of focal spot 30. Inclusion of a radiation barrier impregnated with a heavy element and situated between the optical alignment assembly 6 and the operator, combined with micrometric adjusters (e.g., adjustment screws 43a-b), facilitates these off-axis corrections to be executed in real time with an energized X-ray source from an X-ray tube 1. Occasionally, a nominal alteration to the rotation angle (Θ) may also be used to achieve an ideal X-ray beam 5 profile. For embodiments incorporating a capillary lens the alignment process can be exploited to refine the count rate at the focal spot 30 by employing count rate detectors as delineated in the foregoing procedures.

For a capillary lens optic, the focal point distances are given by the vendor and must be precisely followed in order to achieve the performance stated by the vendor. Using an r-Θ mechanism, as disclosed herein, for the lens optic allows rapid and precise alignment to the X-ray tube 1 emission spot 28 with minimal time and effort.

FIG. 7 illustrates another example of a flow diagram of a method 400 of aligning an optical train 53 of an XRF system 100 in accordance with some embodiments. The method may begin at block 402. The method 400 may include the process(es) performed at block 404, which may comprise emitting X-rays from an X-ray tube 1 along a central axis, such as the Z-axis. The method 400 may include the process(es) performed at block 406, which may comprise adjusting an optical alignment assembly 6 in a first linear direction perpendicular to the central axis and a first rotational direction around the central axis to align the optical alignment assembly 6 with the X-ray tube 1. The method 400 may include the process(es) performed at block 408, which may comprise illuminating a sample 7 with maximized X-ray intensity and desired focal spot 30 shape. The method 400 may end at block 410. In some embodiments, the adjusting performed at block 406 step may involve translating a flight tube 36 by a predetermined distance and rotating the optical alignment assembly 6 by a specific angle. In some embodiments, the method 400 may include observing the sample 7 during the adjustment to ensure a desired focal spot 30 size, focal spot 30 shape, and maximum X-ray flux or fluence is achieved during alignment. In some embodiments, all rotations and translations described herein may be motorized and/or automated, facilitated by a computing device 200.

### Features of the Disclosure

In some embodiments, an alignment apparatus for an X-ray source may include an X-ray tube configured to emit X-rays. The alignment apparatus for an X-ray source may include an optical alignment assembly situated between the X-ray tube and a sample. The optical alignment assembly may include a flight tube and at least one adjustment mechanism. The optical alignment assembly may be adjustable to ensure the emitted X-rays produce an illumination on the sample with maximized X-ray intensity and desired spot shape.

In some embodiments, the X-ray tube may include an envelope configured to provide a sub-atmospheric environment. The X-ray tube may include a cathode disposed within the envelope. The cathode may include a filament configured to be a source for electrons to be emitted by the cathode. The X-ray tube may include an anode disposed within the envelope and may include an emission spot where the electrons emitted by the cathode impact, decelerate, and result in the emission of X-rays. The envelope may define an exit window situated to allow the emitted X-rays to exit the X-ray tube while maintaining the sub-atmospheric environment within the envelope. In some embodiments, the flight tube may be configured to carry and center at least one of a plurality of pinhole apertures while allowing for translation of the flight tube. The flight tube may include at least one entry pinhole aperture providing initial collimation of divergent X-rays emitted by the emission spot. The flight tube may include at least one exit pinhole aperture providing final collimation of the X-rays transmitted through the entry pinhole aperture.

In some embodiments, the flight tube may be configured to carry and center a capillary lens or a reflection optical assembly. In some embodiments, the optical alignment assembly may include additional pinhole apertures positioned between the at least one entry pinhole aperture and the at least one exit pinhole aperture to modify a focal spot size, shape, and fluence. In some embodiments, the at least one adjustment mechanism may be configured to translate the flight tube by a distance in tension against at least one retainer device. In some embodiments, the at least one adjustment mechanism may include at least one adjustment screw or at least one micrometer in tension against the at least one retainer device. In some embodiments, the at least one adjustment screw or the at least one micrometer may allow for off-axis correction of the optical alignment assembly to compensate for dimensional errors associated with a fixturing assembly. In some embodiments, the optical alignment assembly may include a slotted hole running a length of the optical alignment assembly to allow for translation of the flight tube.

In some embodiments, the flight tube may include a tube having an internal sleeve configured to suppress parasitic X-ray fluorescence. In some embodiments, the optical alignment assembly may be configured to project a focal spot on a surface of the sample for analysis. In some embodiments, the sample may be an imaging X-ray sensor or an X-ray count rate sensor used for r-theta alignment of the optical alignment assembly. In some embodiments, the optical alignment assembly may include a solid cylinder with a machined slot allowing for maximum travel of a collimator train or a capillary lens assembly. In some embodiments, the optical alignment assembly may be configured for polar coordinate and translational alignment. In some embodiments, the X-ray tube or the optical alignment assembly may be configured to move relative to the sample. In some embodiments, the sample may be configured to move relative to the optical alignment assembly.

In some embodiments, a method may include emitting X-rays from an X-ray tube along a central axis. The method may include adjusting an optical alignment assembly in a first linear direction perpendicular to the central axis and a first rotational direction around the central axis to align the optical alignment assembly with the X-ray tube. The method may include illuminating a sample with maximized X-ray intensity and desired spot shape.

In some embodiments, the adjusting step may involve translating a flight tube by a predetermined distance and rotating the optical alignment assembly by a specific angle. In some embodiments, the method may include observing the sample during the adjustment to ensure a desired focal size, shape, and maximum X-ray flux or fluence is achieved during alignment.

In some embodiments, a method may include providing a reference device for analysis. The method may include adjusting a radial distance of an optical train. The method may include energizing an X-ray tube to a predetermined voltage and emission current. The method may include recording an X-ray count. The method may include moving an optical alignment assembly to a first radius value perpendicular to a central axis. The method may include adjusting an angle (Θ) of the optical alignment assembly through a full 360-degree rotation while the X-ray count rate is monitored to identify the angle at which the X-ray count rate is maximized. The method may include recalibrating the optical train based on the previously observed maximum flux.

In some embodiments, the adjustment of the angle (Θ) may be performed incrementally or continuously. In some embodiments, the method may include moving the optical alignment assembly to at least a second radius value. In some embodiments, the method may include observing the reference device during the angle adjustment and movement to at least one of the radius values to ensure a desired spot size, spot shape, and maximum X-ray flux or fluence is achieved. In some embodiments, the angle adjustment and the movement of the optical alignment assembly to the first radius value is motorized or automated.

In addition, the methods and systems described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

In this application, including the definitions below, the term “module” or the term “controller” may be replaced with the term “circuit.” The term “module” may refer to, be part of, or include processor hardware (shared, dedicated, or group) that executes code and memory hardware (shared, dedicated, or group) that stores code executed by the processor hardware.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are the BLUETOOTH wireless networking standard from the Bluetooth Special Interest Group and IEEE Standard 802.15.4.

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

It may be emphasized that the above-described embodiments, particularly any “preferred” embodiments, are merely possible examples of implementations, set forth for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

While this specification contains many specifics, these should not be construed as limitations on the scope of any disclosures, but rather as descriptions of features that may be specific to a particular embodiment. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. An alignment apparatus for an X-ray source comprising:
an X-ray tube configured to emit X-rays;
an optical alignment assembly situated between the X-ray tube and a sample, the optical alignment assembly comprising:
a flight tube; and
at least one adjustment mechanism,
wherein the optical alignment assembly is adjustable to ensure the emitted X-rays produce an illumination on the sample with maximized X-ray intensity and desired spot shape.

2. The alignment apparatus of claim 1, wherein the X-ray tube comprises:
an envelope configured to provide a sub-atmospheric environment;
a cathode disposed within the envelope, the cathode including a filament configured to be a source for electrons to be emitted by the cathode;
an anode disposed within the envelope and including an emission spot where the electrons emitted by the cathode impact, decelerate, and result in the emission of X-rays; and
wherein the envelope defines an exit window situated to allow the emitted X-rays to exit the X-ray tube while maintaining the sub-atmospheric environment within the envelope.

3. The alignment apparatus of claim 2, wherein the flight tube is configured to carry and center at least one of a plurality of pinhole apertures while allowing for translation of the flight tube, the flight tube further comprising:
at least one entry pinhole aperture providing initial collimation of divergent X-rays emitted by the emission spot; and
at least one exit pinhole aperture providing final collimation of the X-rays transmitted through the entry pinhole aperture.

4. The alignment apparatus of claim 2, wherein the flight tube is configured to carry and center a capillary lens or a reflection optical assembly.

5. The alignment apparatus of claim 3, wherein the optical alignment assembly comprises additional pinhole apertures positioned between the at least one entry pinhole aperture and the at least one exit pinhole aperture to modify a focal spot size, shape, and fluence.

6. The alignment apparatus of claim 1, wherein the at least one adjustment mechanism is configured to translate the flight tube by a distance in tension against at least one retainer device.

7. The alignment apparatus of claim 6 wherein the at least one adjustment mechanism includes at least one of an adjustment screw or at least one micrometer in tension against the at least one retainer device.

8. The alignment apparatus of claim 7, wherein the at least one adjustment screw or the at least one micrometer allows for off-axis correction of the optical alignment assembly to compensate for dimensional errors associated with a fixturing assembly.

9. The alignment apparatus of claim 1, wherein the optical alignment assembly comprises a slotted hole running a length of the optical alignment assembly to allow for translation of the flight tube.

10. The alignment apparatus of claim 1, wherein the flight tube includes a tube having an internal sleeve configured to suppress parasitic X-ray fluorescence.

11. The alignment apparatus of claim 1, wherein the optical alignment assembly is configured to project a focal spot on a surface of the sample for analysis.

12. The alignment apparatus of claim 11, wherein the sample is an imaging X-ray sensor or an X-ray count rate sensor used for r-theta alignment of the optical alignment assembly.

13. The alignment apparatus of claim 1, wherein the optical alignment assembly comprises a solid cylinder with a machined slot allowing for maximum travel of a collimator train or a capillary lens assembly.

14. The alignment apparatus of claim 1, wherein the optical alignment assembly is configured for polar coordinate and translational alignment.

15. The alignment apparatus of claim 1, wherein the X-ray tube or the optical alignment assembly are configured to move relative to the sample.

16. The alignment apparatus of claim 1, wherein the sample is configured to move relative to the optical alignment assembly.

17. A method comprising:
emitting X-rays from an X-ray tube along a central axis;
adjusting an optical alignment assembly in a first linear direction perpendicular to the central axis and a first rotational direction around the central axis to align the optical alignment assembly with the X-ray tube; and
illuminating a sample with maximized X-ray intensity and desired spot shape.

18. The method of claim 17, wherein the adjusting step involves translating a flight tube by a predetermined distance and rotating the optical alignment assembly by a specific angle.

19. The method of claim 17, further comprising observing the sample during the adjustment to ensure a desired focal size, shape, and maximum X-ray flux or fluence is achieved during alignment.

20. A method comprising:
providing a reference device for analysis;
adjusting a radial distance of an optical train;
energizing an X-ray tube to a predetermined voltage and emission current;
recording an X-ray count;
moving an optical alignment assembly to a first radius value perpendicular to a central axis;
adjusting an angle (Θ) of the optical alignment assembly through a full 360-degree rotation while the X-ray count rate is monitored to identify the angle at which the X-ray count rate is maximized; and
recalibrating the optical train based on the previously observed maximum flux.

21. The method of claim 20, wherein the adjustment of the angle (Θ) is performed incrementally or continuously.

22. The method of claim 20, further comprising moving the optical alignment assembly to at least a second radius value.

23. The method of claim 22, further comprising observing the reference device during the angle adjustment and movement to at least one of the radius values to ensure a desired spot size, spot shape, and maximum X-ray flux or fluence is achieved.

24. The method of claim 20, wherein the angle adjustment and the movement of the optical alignment assembly to the first radius value is motorized or automated.
